(19) United States
(12) Patent Application Publication
(10) Pub. No.: US 2023/0382152 A1
(43) Pub. Date: Nov. 30, 2023

(54) Transfer Sheet For Easy Home Use

(71) Applicant: Ready, Set, Co., LLC, Plymouth, MN (US)

(72) Inventors: Jodi Schwendimann, Wayzata, MN (US); Hemant Bohra, Minnetonka, MN (US)

(73) Assignee: Ready, Set, Co., LLC, Plymouth, MN (US)

(21) Appl. No.: 18/319,961

(22) Filed: May 18, 2023

Related U.S. Application Data
(60) Provisional application No. 63/345,304, filed on May 24, 2022.

(51) Int. Cl. B44C 1/17; B41M 3/12

(52) U.S. Cl. CPC B44C 1/1716; B44C 1/1729; B41M 3/12; G03C 11/12

(57) ABSTRACT

Image transfer articles including a substrate comprising a top surface and a bottom surface, a melt transfer layer having a top surface and a bottom surface, the bottom surface removably located on the top surface of the substrate, and an image receiving layer having an image receiving surface configured to receive indicia or an image and positionable against a receptor element during a transfer process, wherein the image receiving layer comprises at least one wax coated silica. The image receiving layer may further include at least one binder such as an ethylene acrylic acid binder. The imaging layer may also include wax-based water repellant, and together the wax coated silica and wax-based water repellant may comprise about 30% to about 40% of the image receiving layer on a dry weight basis.

### BACKGROUND

Textiles such as shirts (e.g., tee shirts) having a variety of designs thereon have become very popular in recent years. Many shirts are sold with pre-printed designs to suit the tastes of consumers. In addition, many customized tee shirt stores are now in the business of permitting customers to select designs or decals of their choice. Processes have also been proposed which permit customers to create their own designs on transfer sheets for application to tee shirts by use of a conventional hand iron, such as described in U.S. Pat. No. 4,244,358 issued Sep. 23, 1980. Furthermore, U.S. Pat. No. 4,773,953 issued Sep. 27, 1988, is directed to a method for utilizing a personal computer, a Video camera or the like to create graphics, images, or creative designs on a fabric.

U.S. Pat. No. 5,620,548 is directed to a silver halide photographic transfer element and to a method for transferring an image from the transfer element to a receptor surface. Provisional application No. 60/029,917 discloses that the silver halide light sensitive grains be dispersed within a carrier that functions as a transfer layer and does not have a separate transfer layer. Provisional application No. 60/056,446 discloses that the silver halide transfer element has a separate transfer layer. Provisional Application No. 60/0156,593 relates to dye sublimation thermal transfer paper and transfer method. Provisional Application No. 60/065,806 relates to a transfer element using CYCOLOR technology and has a separate transfer layer. Provisional Application No. 60/065,804 relates to a transfer element using thermo-autochrome technology and has a separate transfer layer. Provisional Application No. 60/030,933 relates to a transfer element using CYCOLOR and thermo-autochrome technology but having no separate transfer layer.

U.S. Pat. No. 5,798,179 is directed to a printable heat transfer material using a thermoplastic polymer such as a hard acrylic polymer or poly (Vinyl acetate) as a barrier layer and has a separate film-forming binder layer.

U.S. Pat. No. 5,271,990 relates to an image-receptive heat transfer paper which includes an image-receptive melt transfer film layer comprising a thermoplastic polymer over laying the top surface of a base sheet.

U.S. Pat. No. 5,502,902 relates to a printable material comprising a thermoplastic polymer and a film-forming binder.

U.S. Pat. No. 5,614,345 relates to a paper for thermal image transfer to flat porous surfaces, which contains an ethylene copolymer or an ethylene copolymer mixture and a dye-receiving layer.

One problem with many known transfer sheets is that when conventional transfer materials travel through laser printers or copiers, the high temperature in the printers and copiers partially melts some polymer materials, such as a wax, present in the transfer material. As a result, the laser printer or copier must be frequently cleaned.

### SUMMARY OF THE INVENTION

In order to attract the interest of consumer groups that are already captivated by the t-shirt rage described above, the present invention provides, in one embodiment, an improved transfer sheet. In another embodiment, the present invention provides for a process for preparing the transfer sheet. In another embodiment, the present invention provides for a heat transfer of images to a receptor element. The present invention represents a revolution in the image transfer industry. It is very inexpensive, has a very soft feel to the touch, and can be washed in the washing machine with detergent. No special washing or drying procedures are required in order to preserve the transferred image. Additionally, it includes the advantages of a transfer with hand-iron which allows easy home-use advantage. The transfer could be conducted using ‘hot peel’ or ‘cold peel’ transfer techniques on light colored receptors; where upon re-ironing the ‘cold peel’ transfers, the transfer feel could be altered to match that of a ‘hot peel’ transfer. In this ‘hot peel’ or ‘cold peel’ transfer process, the image placed on the imaging material is transferred directly to the receptor element with the need of an inverted or reversed image.

The imaging material of the present invention can be imaged upon using electronic means or craft-type marking. The electronic means may be, for example, electrostatic printers including but not limited to laser printers or laser copiers (color or monochromatic). Further, the present invention may be practiced using craft-type markings such as, for example, markers, crayons, paints or pens.

The present invention relates to an image transfer material, comprising a support, a melt transfer layer, and an image receiving layer. The image receiving layer may contain a wax treated pigment such as a wax coated silica and an ethylene acrylic acid copolymer. Wax treated pigment, when optionally used in conjunction with other wax components such as wax based water repellant and a binder improves the color retention while reducing or eliminating wax build-up in the laser printer. For example, the use of conventional wax systems generally causes a wax buildup in laser printers causing the printers to jam. By using wax treated pigments and wax-based water repellant in combination with an ethylene acrylic acid co-polymer binder, the present image receiving layer incorporates a wax component without creating a risk of wax build up and paper jamming in the printer. The ethylene acrylic acid preferably melts in the range of from 65° C. to about 180° C. The combination of these ingredients also impart very good transfer characteristics while using hand iron making the transfer sheet home-use friendly.

The present invention further relates to a process for preparing the above image transfer material. According to the present invention, the optional barrier layer is coated on the support, the melt transfer layer is applied onto the optionally barrier-coated support, and image receiving layer is coated onto the melt transfer layer. Ways of applying the melt transfer layer include extrusion and lamination.

The present invention further relates to a heat transfer process using the present image transfer material. First, the top surface of the image receiving layer is imaged using digital printing methods such as electrostatic/laser printing and HP Indigo printing technique. Next, the imaged sheet is placed image side against a receptor (such as, for example, a tee shirt). Heat and pressure are applied to the non-image side of the support to transfer the melt transfer layers(s) and the image receiving layer(s) while using a hand-iron or heat press. The support is removed before cooling (hot peel) or alternatively, support sheet is removed upon cooling (cold peel).

In some embodiments, when a laser printer or laser copier is used to image the imaging material of the present invention, the imaging material of the present invention may optionally comprise an antistatic layer, which is coated on the backside of the substrate (i.e., the side that was not previously coated with the melt transfer layer, etc.). The resulting image can be transferred to a receptor element such as a t-shirt using heat and pressure from a hand iron or a heat press.

Various embodiments include image transfer articles including a substrate having a top surface and a bottom surface, a melt transfer layer having a top surface and a bottom surface, the bottom surface removably located on the top surface of the substrate, and an image receiving layer having an image receiving surface configured to receive indicia or an image and positionable against a receptor element during a transfer process, wherein the image receiving layer comprises at least one wax coated silica. The image receiving layer may further include a binder such as an ethylene acrylic acid binder. The wax coated silica may be comprised of particles having a size of between about 4 and about 10 micrometers. The image receiving layer may further include a wax-based water repellant. In such embodiments, the wax coated silica and wax-based water repellant comprise about 30% to about 40% of the image receiving layer on a dry weight basis. The melt transfer layer may be configured to adhere the melt transfer layer and the image receiving layer to the receptor element when the melt transfer article is heated with a hand iron. The image receiving layer may be configured to receive printed images from electrostatic printers including both laser printers and liquid toner printers including from non-OEM toners.

In other embodiments, the image transfer article includes a support having a top surface and a bottom surface, a melt transfer layer on the top surface of the support, an image receiving layer on the melt transfer layer, the image receiving layer having an image receiving surface configured to receive indicia or an image, the image receiving layer comprising a one wax treated silica pigment and an ethylene acrylic acid binder, and an anti-static coating on the bottom surface of the support opposite the melt transfer layer. The image receiving layer may further include at least one binder such as an ethylene acrylic acid binder. The wax coated silica may be comprised of particles having a size of between about 4 and about 10 micrometers The image receiving layer may also include a wax-based water repellant. In some such embodiments, the wax coated silica and wax-based water repellant may comprise about 30% to about 40% of image receiving layer on a dry weight basis. These embodiments exhibit good transfer characteristics with hand iron and may receive printed images from electrostatic printers including both laser printers and liquid toner printers including from non-OEM toners.

### BRIEF DESCRIPTION OF THE DRAWINGS

The present invention will become more fully understood from the detailed description given hereinbelow, and the accompanying drawings that are given by way of illustration only and thus are not limiting of the present invention, and wherein:

FIG. 1 is a cross-sectional view of the preferred embodiment of the transfer element of the present invention;

FIG. 2 illustrates the image transfer procedure; and

FIG. 3 illustrates the step of ironing the transfer element onto a t-shirt or the like.

### DETAILED DESCRIPTION OF THE INVENTION

The present application claims priority to provisional application No. 63/345,304, filed May 24, 2022 and entitled Transfer Sheet For Easy Home Use, the disclosure of which is hereby incorporated by reference in the entirety.

The present invention relates to a transfer sheet and methods of transferring image areas and non-image areas of a transfer sheet to a receptor element. In some embodiments, the transfer sheet includes image transfer paper which is printed using an electrostatic/laser printer and copier or other devices in which toner particles are image-wise applied to a substrate. The transfer sheets include applied images which are capable of being directly transferred to, for instance, a receiver such as a light-colored or white colored textile, such as a shirt or the like with the use of hand-iron.

Accordingly various embodiments include a support coated with melt transfer layer, image receiving layer and optional barrier layer and/or antistatic layer. Because the melt transfer layer provides adhesion to the receptor, no separate adhesive layers are required.

A unique advantage of various embodiments is to enable all consumers to wear and display apparel carrying designs that were formed on the substrate of the present invention by, for example, a photocopier or a computer laser printer in a timely and cost-efficient means. The present invention also allows the use of after-market non-OEM or low-cost toner cartridges to provide additional cost-savings. The transfer sheet exhibits very good transfer characteristics while transferring using a hand iron, thus providing an easy home-use advantage.

A. The Transfer Material

1. Support

The support may be a thin flexible, but non-elastic carrier sheet. The support is not particularly limited and may be any conventional support sheet which is suitably flexible. Typically, the support sheet is a paper web, plastic film, metal foil, wood pulp fiber paper, vegetable parchment paper, lithographic printing paper or similar material, imparting release of melt transfer layer.

The support may provide a surface that will promote or at least not adversely affect image adhesion and image release. An appropriate support may include but is not limited to a cellulosic nonwoven web or film, such as a smooth surface, heavy weight (approximately 24 lb.) laser printer or color copier paper stock or laser printer transparency (polyester) film. The support in various embodiments may be a sheet of laser copier/printer paper or a polyester film base. However, highly porous substrates may be less preferred in some embodiments because they tend to absorb large amounts of the coating(s) or toner in copiers without providing as much release. The support preferably provides sufficient strength for handling, copying, coating, heat transfer, and other operations associated with the present invention. Alternatively, available release liners with pre-coated barrier layer on the surface could be utilized for the support layer. Substrates containing a release coated surface, such as a coating of fluorocarbon, urethane, acrylic base polymer or silicone as a release coating, may be utilized as support layer of the present invention. The silicone coating may have a release value of about 10 to 2500 g/inch, using a Tesa Tape 7375 tmi, 90 degree angle, 1 inch tape, 12 inches per minute, for example. Accordingly, in accordance with some embodiments of the present invention, the substrate may be the base material for any printable material, such as described in U.S. Pat. No. 5,271,990 and RE41,623.

In accordance with other embodiments of the invention, the substrate must be usable in a laser copier or laser printer. For example, the substrate for this embodiment may be equal to or less than approximately 4.0 mils thick. Since this substrate is useable in a laser copier or laser printer, antistatic agents may be present. The antistatic agents may be present in the form of a coating on the back surface of the support as an additional layer. The back surface of the support is the surface that is not coated with the image receiving layer, melt transfer layer, optional barrier layer, etc.

When the antistatic agent is applied as a coating onto the back surface of the support, the coating may help eliminate copier or printer jamming by preventing the electrostatic adhesion of the paper base to the copier drum of laser and electrostatic copiers and printers. Antistatic agents, or “antistats’ are generally, but not necessarily, conductive polymers that promote the flow of charge away from the paper.

Antistats can also be “humectants’ that modulate the level of moisture in a paper coating that affects the buildup of charge. Antistats are commonly charged tallow ammonium compounds and complexes, but also can be complexed organometallics. Antistats may also be charged polymers that have a similar charge polarity as the copier/printer drum; whereby the like charge repulsion helps prevent jamming.

Antistatic agents include, by way of illustration, derivatives of propylene glycol, ethylene oxide-propylene oxide block copolymers, organometallic complexes such as titanium dimethylacrylate oxyacetate, polyoxyethylene oxide polyoxyproylene oxide copolymers and derivatives of cholic acid.

More specifically, commonly used antistats include those listed in the Handbook of Paint and Coating Raw Materials, such as t-Butylaminoethyl methacrylate; Capryl hydroxyethyl imidazoline; Cetethyl morpholinium ethosulfate; Cocoyl hydroxyethyl imidazoline Di(butyl, methyl pyrophosphato) ethylenetitanate di(dioctyl, hydrogen phosphite); Dicyclo (dioctyl)pyrophosphato, titanate; Di(dioctylphosphato) ethylene titanate; Dimethyl diallyl ammonium chloride; Distearyldimonium chloride; N,N′-Ethylene bis-ricinoleamide; Glyceryl mono/dioleate; Glyceryl oleate; Glyceryl stearate, Heptadecenyl hydroxyethylimidazoline; Hexyl phosphate; N(B-Hydroxyethyl) ricinoleamide, N-(2-Hydroxypropyl) benzenesulfonamide; IsO propy 14-a minob en Zen e sulfonyl di(dodecylbenzenesulfonyl)titanate; Isopropyl dimethacryl isostearoyl titanate; isopropyltri(dioctylphosphato) titanate; Isopropyl tri(dioctylpyrophosphato)titanate; Isopropyl tri(N-ethylaminoethylamino) titanate; (3-Lauramidopropyl) trimethyl ammonium methyl sulfate; Nonyl nonoxynol-15; Oleyl hydroxyethylimidazoline; Palmitic/stearic acid mono/diglycerides; PCA; PEG-36 castor oil; PEG-10 cocamine; PEG-2 laurate; PEG-2, tallowamine; PEG-5 tallowamine; PEG-15 tallowamine; PEG-20 tallowamine; Poloxamer 101; Poloxamer 108; Poloxamer 123; Poloxamer 124; Poloxamer 181; Poloxamer 182; Polaxamer 184; Poloxamer 185; Poloxamer 188; Poloxamer 217; Poloxamer 231; Poloxamer 234; Poloxamer 235; Poloxamer 237; Poloxamer 282; Poloxamer 288; Poloxamer 331; Polaxamer 333; Poloxamer 334; Poloxamer 335; Poloxamer 338; Poloxamer 401; Poloxamer 402; Poloxamer 403; Poloxamer 407; Poloxamine 304; Poloxamine 701; Poloxamine 704; Polaxamine 901; Poloxamine 904; Poloxamine 908; Poloxamine 1107; Poloxamine 1307; Polyamide/epichlorohydrin polymer; Polyglyceryl-10 tetraoleate; Propylene glycol laurate; Propylene glycol myristate; PVM/MA copolymer; polyether; Quaternium-18; slearamidopropyl dimethyl-shydroxyethyl ammonium dihydrogen phosphate, stearamidopropyl dimethyl-2-hydroxyethyl ammonium nitrate, sulfated peanut oil; Tetra (2, diallyoxymethyl-1 butoxy titaniumdi (di-tridecyl) phosphite; Tetrahydroxypropyl ethylenediamine; Tetraisopropyl di (dioctylphosphito) titanate; Tetraoctyloxytitanium di (ditridecylphosphite); Titanium di(butyl, octyl pyrophosphate) di (dioctyl, hydrogen phosphite) oxyacetate; Titanium di (cumylphenylate) oxyacetate; Titanium di(dioctylpyrophosphate) oxyacetate; Titanium dimethacrylate oxyacetate.

Marklear AFL-23 or Markstat AL-14, polyethers available from Witco Industries, may be used as an antistatic agent, for example.

The antistatic coating may be applied on the back surface of the support by, for example, spreading a solution comprising an antistatic agent (i.e., with a metering rod) onto the back surface of the support and then drying the substrate.

An example of a support which may be used in various embodiments is Georgia Pacific brand Microprint Laser Paper with an applied barrier coating. However, any commercially available laser copier/printer paper may be used as the support in the present invention.

2. Optional Barrier Layer

The barrier layer is an optional first coating on the support. The barrier layer also assists in releasing the image receiving layer and the melt transfer layer(s). The barrier layer may comprise a polymer that may also help prevent the coating and/or toner from adhering to the support. For instance, barrier layers may include, but are not limited to, the barrier layers disclosed in U.S. Pat. Nos. 6,410,200, 6,358,660, 5,501,902, 5,271,990, and 5,242,739, which are herein incorporated by reference. Other suitable barrier layers include those disclosed in U.S. Pat. Nos. 4,021,591, 4,555,436, 4,657,557, 4,914,079, 4,927, 709, 4,935,300, 5,322,833, 5,413,841, 5,679,461, 5,741,387, 5,798,179, and 5,603,966, all of which are herein incorporated by reference.

When the support performs the same function as the barrier layer, the barrier layer is not required. For example, when the support is a polyester film base, such as polyacetate, there will be minimal adherence to the support by the melt transfer layer. Accordingly, a barrier layer will not be required.

Thus, the barrier layer is a coating that separates the melt transfer layer from the support (such as paper). The barrier layer, when present, is between the support and the melt transfer layer. Furthermore, in various embodiments, the barrier layer is present as both a cold and hot peelable coat and remains with the support after transfer.

The Barrier Layer may be a vinyl acetate with a Tg in the range of from −10° C. to 100° C. Alternatively, the Tg may be in the range of from 0° C. to 100° C. EVERFLEX G, with a Tg of about −7, may be used in various embodiments.

The Barrier Layer, when present, overlays the support. A suitable Barrier Layer may be the barrier layer of U.S. Pat. No. 5,798,179 to Kronzer. The Barrier Layer may be composed of a thermoplastic polymer having essentially no tack at transfer temperatures (e.g., 177 C.), a solubility parameter of at least about 19 (Mpa)′, and a glass transition temperature of at least about 0° C. As used herein, the phrase “having essentially no tack at transfer temperatures’ means that the Barrier Layer does not stick to the Melt Transfer Layer to an extent sufficient to adversely affect the quality of the transferred image. By way of illustration, the thermoplastic polymer may be a hard acrylic polymer or poly (Vinyl acetate). For example, the thermoplastic polymer may have a glass transition temperature (T) of at least about 25° C. As another example, the Tg may be in a range of from about 25 C. to about 100° C. The Barrier Layer also may include an effective amount of a release-enhancing additive, such as a divalent metalion salt of a fatty acid, a polyethylene glycol, or a mixture thereof. For example, the release-enhancing additive may be calcium stearate, a polyethylene glycol having a molecular weight of from about 2,000 to about 100,000, or a mixture thereof.

Lastly, suitable barrier layers include the barrier layers of U.S. Pat. Nos. 4,773,953, 4,980,224, 5,620,548, 5,139,917, 5,236,801, 5,883,790, 6,245,710, 6,083,656, 5,948,586, 6,265,128, 6,033,824, 6,294,307, 6,410,200 and 6,358,660, and U.S. application Ser. Nos. 09/366,300, 09/547,760, 09/637,082, 09/828,134, 09/980,589, 09/453,881, 09/791,755, 10/089,446, and 10/205,628, and Provisional U.S. Application Ser. Nos. 60/396,632 and 60/304,752.

Coat weights for the barrier layer may range from one 1 g/m² to 20 g/m², preferably from 1 g/m² to 15 g/m², most preferably 1 g/m² to 8 g/m². The barrier layer herein may comprise silicon or silicone containing compound.

3. The Melt Transfer Layer

The melt transfer layer is applied on top of the support or on the barrier layer, if present. Any melt transfer layer may be used, for instance, any of the melt transfer layers disclosed in U.S. Pat. Nos. RE41,623E, 6,410,200, 6,358,660, 5,501,902, 5,271,990, 5,242, 739, 4,021,591, 4,555,436, 4,657,557, 4,914,079, 4,927,709, 4,935,300, 5,322,833, 5,413,841, 5,679,461, 5,741,387, 5,798,179, 5,603,966, 4,773,953, 4,980,224, 5,620,548, 5,139,917, 5,236,801, 5,883,790, 6,245,710, 6,083,656, 5,948,586, 6,265,128, 6,033,824, 6,294,307, 6,410,200 and 6,358,660, and U.S. application Ser. Nos. 09/366,300, 09/547,760, 09/637,082, 09/828,134, 09/980,589, 09/453,881, 09/791,755, 10/089,446, and 10/205,628, and Provisional U.S. Application Ser. Nos. 60/396,632 and 60/304,752, all of which are herein incorporated by reference.

The melt transfer layer is formed on the support between an optional barrier layer and an image receiving layer. The melt transfer layer of the present invention facilitates the transfer of the image from the support to the receptor. That is, the melt transfer layer of the present invention provides the properties to effectively transfer the melt transfer layer, image receiving layer and images thereon. Further, the melt transfer layer must also provide for adhesion of the melt transfer layer and the image receiving (i.e., containing both image and non-image areas) layer to the receptor without the requirement of a separate surface adhesive layer.

Preferably, the melt transfer layer has a slight tack which keeps the image receiving layer attached on the support during imaging and handling. That is, the melt transfer layer preferably has sufficient tack to hold it onto the support layer. However, the tack must not be so strong as to permanently bond the melt transfer layer to the support. After printing/copying/drawing the desired image as a mirror or reversed image, the image receiving layer is placed image side against a receptor (such as, for example, a tee shirt). Heat and pressure are applied to the non-image side of the support to transfer the melt transfer layers(s) and the image receiving layer(s) while using a hand-iron or heat press. The support is removed before cooling (hot peel) or alternatively, support is removed upon cooling (cold peel).

The melt transfer layer is coated onto the top of the support or optional barrier layer. The thickness ranges from 1 to 5 mils, preferably 1 to 2 mils, most preferably about 1.5 mils. The melt transfer layer has a dry coat of about 2 to 40 g/m², a preferred dry coat weight would be 10-30 g/m².

The melt transfer layer could be a polyurethane layer having sufficient thickness that upon melting adheres to the receptor element. Preferred thickness for the polyurethane layer range from about 1.0 mils to 2.0 mils.

Any polyester, acrylic polymer, polyolefin, polyurethane, ethylene acrylic acid, ethylene vinyl acetate or copolymer blends may be used for melt transfer layer that exhibits a melt transition temperature in the range 40° C.-250° C., or when the glass transition temperature (Tg) of the polyolefin, polyester, polyurethane, acrylic polymer or copolymer blend is less than about 25 degrees Centigrade. Preferably, the Tg will fall between about 25° C. and 120° C. and display a slight tack when touched. Non-limiting examples include polyamide (4220; Bemis Associates), polyurethane (5250; Bemis Associates; Estane™ 5700 series, in particular Estane™ 5703 TPU of Noveon, Inc. Cleveland Ohio; or Daotan polyure thanes by Surface Specialties, Inc. UBC), polyester (UAF 425 or PAF-1 10; Adhesive Films, Inc.), and polyester (Integral Film 801: Dow Co.)

In one embodiment, the melt transfer layer comprises an ethylene vinyl acetate/ethylene acrylic acid copolymer blend. In another embodiment, the melt transfer layer comprises a EVA based terpolymer of ethylene-vinyl acetate and maleic anhydride terpolymer. In another embodiment, the melt transfer layer comprises polyurethane. Aspects of the polyurethane that are important include the softening temperature, softness of the polymer, color of the polymer and elasticity of the polymer. It is desirable to use a polyurethane that is as soft as possible but has high elastic properties. Polyurethane products having a Shore Hardness between 70 A and 90 A are preferred. Non-yellowing of the melt transfer layer is important and therefore the polyurethane should be non-yellowing. Aliphatic polyurethanes are more UV stable than other polyurethanes Such as aromatic polyurethanes and therefore can possess better non-yellowing properties.

In a preferred embodiment of the invention, the melt transfer layer comprises an ethylene acrylic acid co-polymer dispersion. The melt transfer layer could also be obtained upon extrusion coating ethylene acrylic acid or ethylene vinyl acetate copolymers. The melt transfer layer may also contain an acrylic dispersion, an elastomeric emulsion, a water repellant and a plasticizer.

The acrylic dispersion is present in a sufficient amount so as to provide adhesion of the melt transfer layer and image to the receptor element upon application of heat. The elastomeric emulsion provides the elastomeric properties such as mechanical stability, flexibility and stretchability. The water repellent provides water resistance and repellency, which enhances the wear resistance and washability of the image on the receptor. The plasticizer provides plasticity and antistatic properties to the transferred image. The acrylic dispersion may be an ethylene acrylic acid co-polymer dispersion that is a film-forming binder that provides the “release’ or “separation’ from the support. The melt transfer layer of the invention may utilize the film-forming binders of the image-receptive melt-transfer film layer of U.S. Pat. No. 5,242,739, which is herein incorporated by reference.

Thus, the nature of the film-forming binder is not known to be critical. That is, any film-forming binder can be employed so long as it meets the criteria specified herein. As a practical matter, water-dispersible ethylene-acrylic acid copolymers have been found to be especially effective film forming binders.

The term “melts” and variations thereof are used herein only in a qualitative sense and are not meant to refer to any particular test procedure. Reference herein to a melting temperature or range is meant only to indicate an approximate temperature or range at which a polymer or binder melts and flows under the conditions of a melt-transfer process to result in a substantially smooth film.

Manufacturers' published data regarding the melt behavior of polymers or binders correlate with the melting requirements described herein. It should be noted, however, that either a true melting point or a softening point may be given, depending on the nature of the material. For example, materials such as polyolefins and waxes, being composed mainly of linear polymeric molecules, generally melt over a relatively narrow temperature range since they are somewhat crystalline below the melting point.

Melting points, if not provided by the manufacturer, are readily determined by known methods such as differential scanning calorimetry. Many polymers, and especially copolymers, are amorphous because of branching in the polymer chains or the side-chain constituents. These materials begin to soften and flow more gradually as the temperature is increased. It is believed that the ring and ball softening point of such materials, as determined by ASTM E-28, is useful in predicting their behavior. Moreover, the melting points or softening points described are better indicators of performance than the chemical nature of the polymer or binder.

In another embodiment of the invention, the polymer may be applied to optionally barrier-coated support in powder form, and then, heat is applied to form a coherent mass of the polymer on the support. This process is often referred to in the textile industry as powder sintering. Any polyethylene, polyamide or blends thereof may be used in the process. Vestamelt 350, 432,730,732 and 750 (Degussa Corp.) are examples of a polyolefin polyamide blends with a typical melt transition temperature in the range of 105-130° C. Polyethylene powders are typically low-density polyethylene (LDPE) compositions with a melt temperature in the range 50-250° C. preferably 70-190° C. and most preferably 80-150° C. LDPE examples include Microthene F501 (Equistar Chemical Co.) with a melt temperature of 104° C., and Icotex 520-5016 (Icopolymers Co.) with a melt temperature of 100° C.

Another component of Melt Transfer Layer could be an elastomeric emulsion, preferably a latex, and is compatible with the other components, and formulated to provide durability, mechanical stability, and a degree of soft ness and conformability to the layers.

Films of this material must have moisture resistance, low tack, durability, flexibility and softness, but with relative toughness and tensile strength. Further, the material should preferably have inherent heat and light stability. The latex can be heat sensitized, and the elastomer can be self-crosslinking or used with compatible cross-linking agents, or both. The latex should be sprayable, or roll stable for continuous runnability on nip rollers.

Elastomeric latexes of the preferred type are produced from the materials and processes set forth in U.S. Pat. Nos. 4,956,434 and 5,143,971, which are herein incorporated by reference. This curable latex is derived from a major amount of acrylate monomers such as C to Cs alkyl acrylate, preferably n-butyl acrylate, up to about 20 parts per hundred of total monomers of a monolefinically unsaturated dicarboxylic acid, most preferably itaconic acid, a small amount of crosslinking agent, preferably N-methyl acrylamide, and optionally another monolefinic monomer.

Using a modified semi batch process in which preferably the itaconic acid is fully charged initially to the reactor with the remaining monomers added over time, a latex of unique polymer architecture or morphology is created, leading to the unique rubbery properties of the cured films produced there from.

One of the ingredient of Melt Transfer Layer could be a water resistant and adhesion aid such as a polyurethane dispersion. Preferably, the polyurethane will be a self-crosslinking formulation incorporating crosslinking agents Such as melamine. This ingredient is also a softener for the acrylic dispersion and plasticizer aid.

Such polyurethane product may be produced by polymerizing one or more acrylate and other ethylenic monomers in the presence of an oligourethane to prepare oligourethane acrylate copolymers. The oligourethane is preferably prepared from diols and diisocyanates, the aliphatic or alicyclic based diisocyanates being preferred, with lesser amounts, if any, of aromatic diisocyanates, to avoid components which contribute to yellowing. Polymerizable monomers, in addition to the usual acrylate and methacrylate esters of aliphatic monoalcohols and styrene, further include monomers with carboxyl groups, such as acrylic acid or methacrylic acid, and those with other hydrophylic groups such as the hydroxyalkyl acrylates (hydroxyethyl methacrylate being exemplary). The hydrophylic groups in these monomers render the copolymer product dispersible in water with the aid of a neutralizing agent for the carboxyl groups, such as dimethylethanolamine, used in amount to at least partially neutralize the carboxyl groups after dispersion in water and vacuum distillation to remove any solvents used to prepare the urethane acrylic hybrid. Further formulations may include the addition of crosslinking components such as amino resins, strained amines or blocked polyisocyanates. Although pigments and fillers could be added to any of the coating layers. Such use to uniformly tint or color the web could be used for special effect, but would not be used where an image is desired in the absence of background coloration. Urethane acrylic hybrid polymers are further described in U.S. Pat. No. 5,708,072, and their description in this application is incorporated by reference.

Self crosslinking acrylic polyurethane hybrid compositions can also be prepared by the processes and materials of U.S. Pat. No. 5,691,425, herein incorporated by reference. These are prepared by producing polyurethane macromonomers containing acid groups and lateral vinyl groups, optionally terminal vinyl groups, and hydroxyl, urethane, thioureathane and/or urea groups. Polymerization of these macromonomers produces acrylic polyurethane hybrids which can be dispersed in water and combined with crosslinking agents for solvent-free coating compositions.

Auto-crosslinkable polyurethane-vinyl polymers are discussed in detail in U.S. Pat. Nos. 5,623,016 and 5,571,861, and their disclosure of these materials is incorporated by reference. The products usually are polyurethane acrylic hybrids, but with self-crosslinking functions. These may be carboxylic acid containing, neutralized with, e.g. tertiary amines such as ethanolamine, and form useful adhesions and coatings from aqueous dispersion.

The elastomeric emulsion and polyurethane dispersion are, generally, thermoplastic elastomers. Thermoplastic elastomeric polymers are polymer blends and alloys which have both the properties of thermoplastic polymers, such as having melt flow and flow characteristics, and elastomers, which are typically polymers which cannot melt and flow due to covalent chemical crosslinking (Vulcanization) or regions (blocks) of highly ordered polymeric units. Thermoplastic elastomers are generally synthesized using two or more monomers that are incompatible; for example, styrene and butadiene. By building long runs of polybutadiene with intermittent polystyrene runs, microdomains are established which imparts the elastomeric quality to the polymer system. However, since the microdomains are established through physical crosslinking mechanisms, they can be broken by application of added energy, such as heat from a hand iron, and caused to melt and flow; and therefore, are elastomers with thermoplastic quality.

Thermoplastic elastomers have been incorporated into the present invention in order to provide the image system with elastomeric quality. Two thermoplastic elastomer Systems have been introduced; that is, a polyacrylate terpolymer elastomer (for example, Hystretch V-29) and an aliphatic urethane acryl hybrid (for example, Daotan VTW 1265). Thermoplastic elastomers can be chosen from a group that includes, for example, ether-ester, olefinic, polyether, polyester and styrenic thermoplastic polymer systems. Specific examples include, by way of illustration, thermoplastic elastomers such as polybutadiene, polybutadiene derivatives, polyurethane, polyurethane derivatives, styrene-butadiene, styrene-butadiene-styrene, acrylonitrile-butadiene, acrylonitrile-butadiene-styrene, acrylonitrile-ethylene-styrene, polyacrylates, polychloroprene, ethylene-vinyl acetate and poly (vinyl chloride). Generally, thermoplastic elastomers can be selected from a group having a glass transition temperature (Tg) ranging from about −50° C. to about 25° C.

Although polyurethane is one component of one of the embodiments of the present melt transfer layer, the melt transfer layer may comprises polyurethane as the main or single component. The melt transfer layer as a polyurethane layer preferably has sufficient thickness that upon melting adheres to the receptor element. Preferred thickness for the polyurethane layer range from about 1.0 mils to 2.0 mils.

One of the component of Melt Transfer Layer could be a plasticizer such as a polyethylene glycol dispersion which provides mechanical stability, water repellency, and allows for a uniform, crack-free film. Accordingly, a reason to add the polyethylene glycol dispersion is an aid in the coating process. Further, the polyethylene glycol dispersion acts as a softening agent. A preferred fourth component is Carbowax Polyethylene Glycol 400, available from Union Carbide. An optional fifth ingredient of Melt Transfer Layer is a surfactant and wetting agent such as polyethylene glycol mono ((tetramethylbutyl) phenol) ether. Alternatively, the representative binders, described above that are suitable for Melt Transfer Layer, may be used in lieu of the above-described ethylene acrylic acid copolymer dispersion.

The melt transfer layer could be composed of a crosslinking polymer, for example, polyurethane or polyethylene. When heat is applied to the melt transfer layer, it bonds to the receptor element. The bond created is durable to washing, dry-cleaning, and is durable under mechanical stress.

4. The Image Receiving Layer

An image receiving layer is present over the melt transfer layer. The image receiving layer formulations of the present invention should be able to retain an image. The image receiving layer retains dyes, such as a water-based marker and colorants such as in laser toners. In some embodiments, the image receiving layer may be heat activated (e.g. melt and flow) to trap or encapsulate the colorants and optionally impart water-fast characteristics.

During creation of the transfer sheet, the image receiving layer may be applied to the melt transfer layer either by a conventional saturating process such as a “dip and squeeze’ process or with a coating process such as a reverse roll, meyer rod, gravure, slot die or other process.

The basis weight of the image receiving layer may vary from about 2 to about 30 g/m². In various embodiments, the basis weight will be from about 13 to about 16 g/m².

The image receiving layer may be capable of heat sealing the image upon application of heat up to 220° C. Heat sealing as used herein refers to a process whereby the polymer composition melts and flows so as to effectively encapsulate the image forming colorants therein. Heat sealing may impart water-fastness and washability. A heat-sealed image may have newly imparted image permanence properties such as water-fastness and rub resistance. In some embodiments, the image receiving formulation includes a self-crosslinking polymer as a binder. In such embodiments, although not all components of the image receiving layer may technically melt, for instance, the self-crosslinking EVA polymer may not melt, the layer will still heat seal the image.

The image receiving layer may include binders, such as ethylene acrylic acid copolymers, polyvinyl alcohol (PVOH), polyesters, polyurethanes, or co-polymer blends, vinyl acetate-ethylene, various colorant retention aids, various optional crosslinking agents, an optional antioxidant, and/or an optional softening agent.

The binder may impart colorant retention and mechanical stability. A list of binders which may be used in various embodiments includes, but is not limited to, those listed in U.S. Pat. No. 5,798,179, in addition to polyolefins, polyesters, ethylene-vinyl acetate copolymers, ethylene-methacrylate acid copolymers, and ethylene-acrylic acid copolymers. The binder may also be selected from the list, mentioned herein, for use in the melt transfer layer.

The binder could be one of a self-crosslinkable acrylic copolymer, for instance, Rhoplex™ NW-1402, Rhoplex™ HA-16 or RhopleX™ HA-12 from the Rohm and Haas Corporation, or a hydrolyzed polyvinyl alcohol, for instance, Celvol™ 540 or Celvol™ 125, from the Celanese Corporation, or a self-crosslinking ethylene-vinyl acetate copolymer, for instance, Dur-o-Set™ Elite Plus 25-299A, from Vinamul Polymers Corp.

The self-crosslinkable polymer binder may be present in an amount, based on the dry solids content of the layer, of 15-40%, and most preferably 25-35% by weight. The self-crosslinkable polymer binder may be a thermosetting polymer such as a self-crosslinking ethylene vinyl acetate copolymer (for instance. Dur-o-set Elite Plus 25-299A, from Vinamul Polymers Corp.).

Thermoplastic binders, other than the self-crosslinkable polymers discussed above, may also be incorporated. For instance, any of the thermoplastic binders listed above for the melt transfer layer may be incorporated. For instance, thermoplastic binders, such as those listed above may be incorporated in amounts of 5-40%, preferably 10-30% by weight based on the dry solids content.

Additionally, a polyamide copolymer, for instance, a nylon copolymer may be added to the image receiving layer. For instance, nylon 6-12 (Orgasol 3501 EXDNAT 1, from Arkema), nylon 12 (Orgasol 2002 EXDNAT 1, from Arkema), and nylon 6 (Orgasol 1002 DNAT1, from Arkema). The formulation may also include a polyvinylpyrrolidone (PVP) polymer and copolymer blends for instance, Luvicross (BASF), Luvicross M (BASF), Luvicross VI (a PVP-vinyl imidazole copolymer blend (BASF)), and Luvitec (BASF).

Although wax can provide useful qualities to the image receiving layer, wax can also cause problems. For example, the use of wax can lead to a wax buildup within laser printers, resulting in jamming of laser printer mechanisms. Because of this, the use of wax was previously either avoided or kept to very low levels in materials used with printer. As described further below, various embodiment described herein include a new method of incorporating wax into the image receiving layer that overcomes the problem of wax buildup in printer mechanisms and printer jamming.

In various embodiments, the image receiving layer includes a wax treated pigment such as a wax coated silica. The wax treated pigment may have a particle size of between about 4 and about 10 micrometers, such as about between about 5 and about 7 micrometers. Examples of wax coated silica which may be used in various embodiments include OK 412, OK 607 available from Evonik (Essen, Germany) or similar wax treated silica.

The wax treated pigment may be included in the image receiving layer in combination with a binder such as an ethylene acrylic acid copolymer. The ethylene acrylic acid may be the only binder or may be used in combination with a co-binder such as a vinyl acetate-ethylene emulsion and polyurethanes.

The image receiving layer including a wax treated silica pigment and ethylene acrylic acid system yields good print attributes with printing without wax build-up in laser printers. The inclusion of one or more wax-treated pigments in the image receiving layer provides additional advantages. For example, wax-treated pigments help reduce the settling of pigments which can be a problem with liquid coatings. In various embodiments, the same image receiving layer is capable of being imaged by any of the various digital imaging techniques such as electrostatic/laser printers and liquid toner printing methods such as HP Indigo. As such, the image receiving layer is highly versatile and may be used by a wide range of customers having many different types of printer systems. The image receiving layer also exhibits very good image and transfer characteristics when used in conjunction with after-market or low-cost toners during laser printing.

The wax treated silica may be used alone or in combination with other wax components such as wax-based water repellants. In such embodiments, a higher amount of wax may be used in the image receiving layer than was previously possible, without causing wax buildup in the printer. For example, the amount of wax treated silica, alone or in combination with other wax such as the wax-based water repellant, may be greater than 30% by weight of the image receiving layer on a dry weight basis. For example, the amount of wax treated silica and wax components may be about 30% to about 40% of the image receiving layer on a dry weight basis.

In some embodiments, the image receiving layer includes wax-coated silica, an ethylene acrylic acid binder, a polyamide which may aid color retention, a water repellant which may provide durability during wash cycles, and surface additives such as surfactants which may provide good surface wetting.

Silica may also be added to the image receiving layer in conjunction with the above wax-treated pigment. Silica is silicon dioxide, and can generally be any preparation that has a mean diameter not larger than 100 microns. Examples include the Syloid brand of silica (such as Syloid W-500, from Grace Davidson Co.), Sylojet brand of silica (such as the Sylojet P400, Grace Davidson Co.), INEOS silica (such as the Gasil HP270 or Gasil IJ45).

An antioxidant may be added to keep the binder from discoloring (yellowing) during the heat process. Suitable antioxidants include, but are not limited to. BHA; Bis(2,4-dit-butylphenyl)pentaerythritol diphosphite; 4,4′-Butylidenebis(6-t-butyl-m-cresol), C20-40 alcohols; p-Crescol/dicyclopentadiene butylated reaction product, Di(butyl, methylpyrophosphato)ethylene titanate di(dioctyl, hydrogen phosphite); Dicyclo(dioctyl)pyrophosphato titanate; DiCdioctylphosphato)ethylene titanate; Di(dioctylpyrophosphato) ethylene titanate; Disobutylnonyl phenol; Dimethylaminom ethyl phenol, Ethylhydroxymethyloleyl oxazoline Isopropyl 4-aminobenzenesulfonyl di(dodecylbenzenesulfonyl)titanate; Isopropyldimethacrylisoslearoyltitanate; Isopropyl (dioctylphosphato)titanate; isopropyltridioctylpyrophosphato) titanate; Isopropyl tri(N ethylamino-ethylamino)titanate, Lead phthalate, basic 2.2-Methylenebis (6-t-butyl-4-methylphenol), Octadecyl 3,5-di-t-butyl-4-hydroxyhydrocinnamate Phosphorus; Phosphorus trichloride, reaction prods. with 1,1′-biphenyl and 2.4-bis(1,1-dimethylethyl)phenol Tetra (2, diallyoxymethyl-1 butoxy titanium di(di-tridecyl) phosphite; Tetraisopropyl di(dioctylphosphito)titanate; Tetrakis methylene (3,5-di-t-butyl-4-hydroxyhydrocinnamate)methane; Tetraoctyloxytitanium; di(ditridecylphosphite); 4,4′-Thiobis-6-(t-butyl-m-cresol): Titanium di(butyl, octyl pyrophosphate)di(dioclyl, hydrogen phosphite)oxyacetate; Titanium di(cumylphenylate)oxyacetate; Titaniumdi (dioctylpyrophosphate), oxyacelate; Titanium dimethyacrylate oxyacetate; 2.2,4-Trimethyl-1,2-dihydro-quinoline polymer, Tris(nonylphenyl)phosphite. Preferably, the antioxidant used is octadecyl 3,5-Ditert-butyl 4-hydroxyhydrocinnamate.

An optional crosslinking agent can be added to each formula to crosslink the binder to improve water fastness. Crosslinkers Suited for this application including, but not limited to, aziridine (ie., Ionac PFAZ-322), aziridine derivatives, multifunctional aziridines (XAMA-7 (Sybron)) Sancure 777 (Noveon), and melamine (ie., Cymul 323 EvCo. Inc.), and organometallics like an organic titanate such as Tyzor LA (DuPont).

The self-crosslinkable polymer binder-containing image receiving formulation may further include dye retention aids, such as a cationic polymer. Other dye retention aids include the silica listed above, the polyamide copolymer and PVA. The cationic polymer may be incorporated in amounts of 1-10% by weight, preferably 1-4% by weight based upon the dry solids content of the layer. Other dye retention aids may include any salt with dissociative properties. Exemplary, but non-limitive examples include salts with Group II elements Such as Mg, CA, Sr or Ba, or other elements such as Al, Zn, and Cu. Preferably CaCl may be utilized as a dye retention aid. The salt with dissociative properties may be present in amounts of 0.25-4%, preferably 1-2% by weight based upon the dry weight of the formulation. The cationic polymer may be, for example, an amide-epichlorohydrin polymer, poly acrylamides with cationic functional groups, polyethyleneimines, polydiallylamines, and the like.

The image receiving layer may contain the addition of filler agents with the purpose of modulating the surface characteristics of the present invention. The surface roughness and coefficient of friction may need to be modulated depending on such factors as desired surface gloss and the imaging device's specific paper feeding requirements.

The filler can be selected from a group of polymers such as, for example, polyacrylates, polyacrylics, polyethylene, polyethylene acrylic copolymers and polyethylene acrylate copolymers, vinyl acetate copolymers and polyvinyl polymer blends that have various particle dimensions and shapes. Typical particle sizes may range from 0.1 to 500 microns. Preferably, the particle sizes range from 5 to 100 microns. More preferably, the particle sizes range from 5 to 30 microns. The filler may also be selected from a group of polymers such as, for example, cellulose, hydroxycellulose, starch and dextran. Silicas and mica may also be selected as a filler. The filler is homogeneously dispersed in the image receiving layer in concentrations ranging from 0.1 to 50%. Preferably, the filler concentration range is 1 to 10 percent.

The image receiving layer may also contain rheology modifiers and defoaming or anti-foaming agents. An example of a rheology modifier is a Laponite product by Southern Clay Products, Inc., Gonzales, Tex.; or AlcogumR L-520 (Alco Chemical).

The image receiving layer functions as a retention aid for the image. Accordingly, the image receiving layer must be modified according to the marker that is being applied. In embodiments where the substrate is marked with a laser copier or printer, the optional image receiving layer may be an acrylic coating upon which an image is applied. The image receiving layer may comprise a film-forming binder including ethylene-acrylic acid copolymers, polyolefins, and waxes or combinations thereof. In some embodiments, especially when a laser copier or laser printer is used, the binder may be an ethylene acrylic acid co-polymer dispersion.

In some embodiments, after the image receiving layer has completely dried, an antistatic agent discussed above may be applied to the non-coated side of the transfer sheet as an antistatic layer 25. The coating will help eliminate copier or printer jamming by preventing the electrostatic adhesion of the paper base to the copier drum of electrostatic copiers and printers.

B. Application of Layers

The various layers of the transfer material are formed by known coating techniques, such as by curtain coating, Meyer rod, roll, blade, air knife, cascade and gravure coating procedures. In addition, it is also possible to apply the melt transfer layer by extrusion coating or lamination.

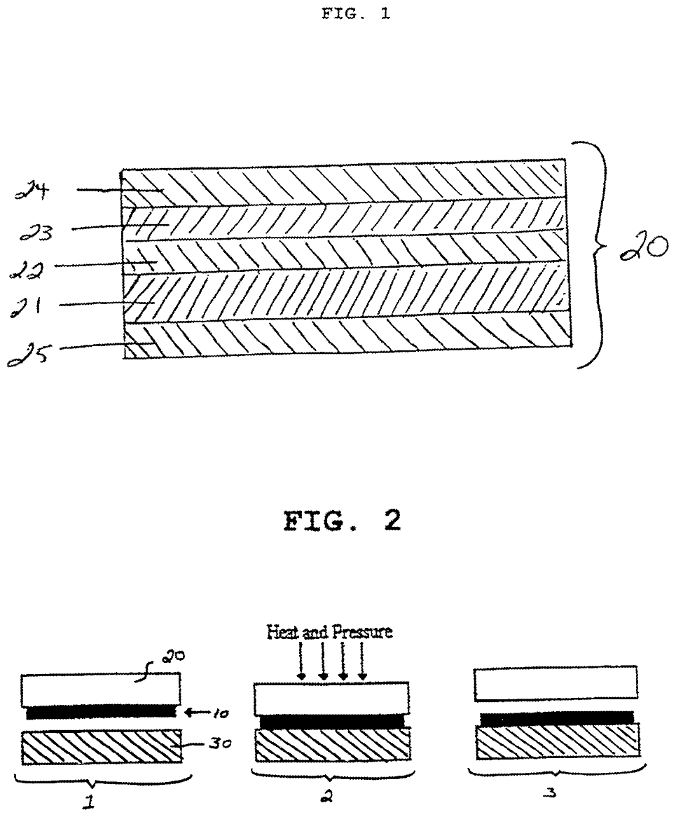

In referring to FIG. 1, there is generally illustrated a cross-sectional view of one embodiment of the transfer sheet of the present invention. The support 21 comprises a top and bottom surface. On the top surface of the support is the optional barrier layer 22. On top of the barrier layer is the melt transfer layer 23. On top of the melt transfer layer is the image receiving layer 24. The image is placed over the image receiving layer 24 on the side opposite the support material. An optional anti-static 25 layer may be coated on the bottom surface of the support 21.

The melt transfer layer may either be extrusion coated or laminated onto the optional barrier coated support. These are performed by methods conventional in the art.

C. Receptor

The receptor or receiving element receives the transferred image. A suitable receptor includes but is not limited to textiles including cotton fabric, and cotton blend fabric. The receptor element may also include glass, metal, wool, plastic, ceramic or any other suitable receptor. Preferably the receptor element is a tee shirt or the like.

The image may be applied to the image receiving layer in any desired manner including printed toner from a color or monochrome laser printer or a color or monochrome laser copier, for example. The image may also be applied to the image receiving layer by writing or drawing with crayons or markers, for example. The image which is printed on or applied to the image receiving layer may be a mirror image or a reversed image of the final image as it appears after application to a substrate.

To transfer the image, the imaged transfer element is placed image side against a receptor. A transfer device (i.e., a hand iron or heat press) is used to apply heat to the substrate which in turn releases the image. The temperature transfer range of the hand iron is generally in the range of 110 to 220° C. with about 190° C. being the preferred temperature. The heat press operates at a temperature transfer range of 100 to 220° C. with about 190° C. being the preferred temperature. The transfer device is placed over the non-image side of the support layer and moved in a circular motion (hand iron only). Pressure (i.e., typical pressure applied during ironing) must be applied as the heating device is moved over the substrate. For a 8.5.x 11 (US Letter) inch web, when heat is applied for about 60 seconds to 300 seconds (with about 210 seconds being preferred) using a hand iron and about 10 seconds to 50 seconds using a heat press (with about twenty seconds being preferred) of heat and pressure, the transfer should be complete. The heating time requirement may be proportionally shorter or longer depending on the web size. The support layer is then peeled away from the image which is adhered to the receptor either prior to cooling (hot peel) or after cooling (cold peel). In the cold peel process, the finish or feel of transfer could be altered to simulate the hot peel method by re-ironing the cold peel transfer with a non-stick sheet. In this process, a non-stick sheet is placed on the surface of cold peel transfer and heat is applied by hand iron or heat press for 30 seconds, then separating the non-stick sheet after 5 seconds.

The non-stick sheet may be any non-stick or tack-free sheet in the art including but not limited to a silicone sheet, a parchment paper sheet, a sheet coated with a barrier layer according to the present invention, or support sheet.

The following examples are provided for a further understanding of the invention; however, the invention is not to be construed as limited thereto.

### Example 1

In one embodiment of the invention, the melt transfer layer is an ethylene acrylic acid co-polymer. An example of this embodiment is Melt Transfer Layer Formulation 1:

Melt Layer Formulation 1

| | Parts by |
|---|---|
| Components | weight |
| Ethylene Acrylic Acid | 100 parts |
| Copolymer Dispersion | |

The Melt Transfer Layer Formulation 1 is coated on a support or optionally barrier coated support in an as supplied liquid dispersion form with a dry coat weight about 2 to 40 g/m², with a preferred dry coat weight would be 10-30 g/m².

### Example 2

This example relates to another melt transfer layer formulation, Melt Transfer Layer Formulation 2.

Melt Layer Formulation 2

| Components | Parts by weight |
|---|---|
| Ethylene Acrylic Acid Copolymer | 100 parts |

The Melt Transfer Layer Formulation 2 is extrusion coated on a support or optionally barrier coated support with a thickness of 1 to 2 mils., with a preferred thickness of 1 to 1.5 mils.

### Example 3

This example relates to an image receiving layer formulation, Image Receiving Layer Formulation 1.

Image Receiving Layer Formulation 1

| | Parts by | |
|---|---|---|
| Components | weight (dry) | |
| 26% Polyamide | 15 to 20 | parts |
| Dispersant | 3 to 4 | parts |
| Wax-treated pigment | 22 to 30 | parts |
| Ethylene acrylic acid copolymer | 35 to 40 | parts |
| Water repellant | 11 to 15 | parts |
| Surfactants | 1 to 2.5 | parts |
| Defoamer or anti-foaming agent | 1 to 2 | parts |
| Rheology modifier | 1 to 2 | parts |

Image Receiving Layer Formulation 1 is displayed in dry parts by weights. However, some of the above ingredients correspond to wet amounts added to create the formulation. To prepare, first stock solution is prepared in water. These are as follows:

26% Polyamide solution

| | Parts by |
|---|---|
| Components | weight (wet) |
| Water | 100 parts |
| Isopropanol | 19 parts |
| Polyamide (Orgasol 3501) | 42 parts |

### Example 4

A transfer sheet according to the present invention is prepared as follows:

A release coated support layer is first extrusion coated with the melt transfer layer (melt transfer layer formulation 2) onto the barrier layer. Second, an Image Receiving Layer (formulation 1) is coated with a meyer rod coater on top of the melt transfer layer surface opposite to the support.

After thermal drying, an image is formed on the side of the image receiving layer opposite the support material by a laser printer.

After 10 inventive transfer sheets are imaged, there is no damage to the laser printer because the wax is present in amounts so as not to adversely affect laser printing or damage the laser printer.

### Example 5

This Example demonstrates the image transfer procedure. Referring to FIG. 2, to transfer the image,
(1) the support 20 is placed image side against a receptor 30 of the present invention. Accordingly, the receptor 30 of this example includes but is not limited to cotton fabric, cotton blend fabric, glass and ceramic. A transfer device of the present invention (i.e., a hand iron or heat press) is used to apply heat to the support 20 which in turn releases the image 10. The temperature transfer range of the hand iron is about 190 C. The heat press operates at a temperature transfer range of about 190° C.
(2) The transfer device is placed over the non-image side of the substrate 20 and moved in a circular motion (if the hand iron is used). Usual pressure applied when ironing is applied as the heating device is moved over the support 20. After about 210 seconds (25 seconds if using the heat press) of heat and pressure, the transfer device is removed from the substrate 20. The support 20 is allowed to cool for about five minutes.
(3) The substrate 20 is then peeled away from the receptor prior to cooling.

### Example 6

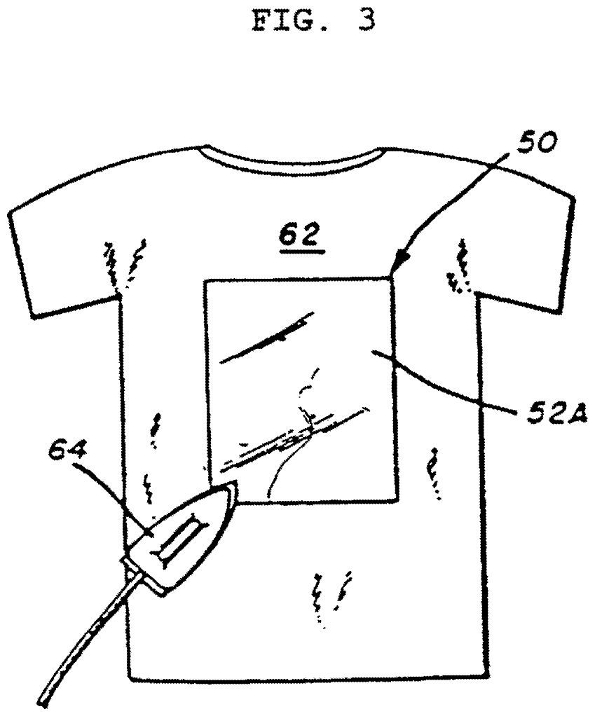

Referring to FIG. 3, the method of applying an image to a receptor element and washing will be described. More specifically, FIG. 2 illustrates how the step of heat transfer from the transfer sheet 50 to a tee shirt or fabric 62 is performed.

The transfer sheet is prepared and imaged upon as described in the Example 5. A tee shirt 62 is laid flat, as illustrated, on an appropriate surface, and the imaged surface of the transfer sheet 50 is positioned onto the tee shirt. An iron 64 set at its highest heat setting is run and pressed across the back 52A of the transfer sheet. The image and nonimage areas are transferred to the tee shirt and the support is removed prior to cooling and discarded.

Lastly, the imaged receptor is washed and dried ten times at normal setting while using a mild laundry detergent with cold wash/cold rinse.

### Example 7

Example 4 is repeated, except that the back surface of the support (opposite the barrier layer) is coated with the following antistatic layer:

Anti-static Layer Formulation 1

| | Parts by |
|---|---|
| Components | weight (wet) |
| Water | 90 parts |
| Quaternary Ammonium Salt | 10 parts |

The Anti-static Layer Formulation 1 is applied in a long line across the top edge of the support material using a #4 metering rod. The coated Support is force air dried for approximately one minute. The antistatic solution of this Example has the following characteristics: the Solution viscosity as measured on a Brookfield DV-II+viscometer, LV1 spindle (a 60 RPM is 2.0 (cP) at 24.5° C. The coating weight (wet) was 15 g/m².

Once the support and antistatic coating are dry, the uncoated side of the support is coated with the melt transfer layer and image receiving layer.

### Example 8

Example 4 is repeated, except that following formulation is used as the antistatic layer on the back of the support:

Anti-static Layer Formulation 2

| | Parts by |
|---|---|
| Components | weight (wet) |
| Water | 95 parts |
| Polyether | 5 parts |

A support layer is first coated with Anti-static Layer Formulation 2 on the uncoated side. Next, a melt transfer layer is extruded on the opposite side of the antistatic layer with Melt Transfer Layer Formulation 2. Next, an Image Receiving Layer Formulation 1 is applied over the melt transfer layer.

After thermal drying, images are then formed on the image receiving layer using a laser printer.

The obtained images are transferred onto a 100% cotton receptor in accordance with Example 5 using a hand iron at 190° C. for 31/2 minutes. The images are allowed to cool for 2 minutes. Once cool, the transfer sheets are peeled away from the receptor (i.e., a cotton tee shirt). The receptor is washed ten times on normal cycle with a mild laundry detergent with cold wash/cold rinse. The imaged receptor exhibited good color saturation and print quality following the wash cycles. Good adhesion to fabric was still observed following the ten wash cycles.

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An image transfer article, comprising:
a substrate comprising a top surface and a bottom surface;
a melt transfer layer having a top surface and a bottom surface, the bottom surface removably located on the top surface of the substrate; and
an image receiving layer having an image receiving surface configured to receive indicia or an image, wherein the image receiving layer comprises at least one wax coated silica, the image receiving layer positionable against a receptor element during a transfer process.

2. The article of claim 1 wherein the image receiving layer further comprising at least one binder.

3. The article of claim 2 wherein the binder comprises an ethylene acrylic acid binder.

4. The article of claim 1 wherein the wax coated silica comprises particles having a size of between about 4 and about 10 micrometers.

5. The article of claim 1, wherein the imaging layer further comprises a wax-based water repellant.

6. The article of claim 5, wherein the wax coated silica and wax-based water repellant comprise about 30% to about 40% of the image receiving layer on a dry weight basis.

7. The article of claim 1, wherein the melt transfer layer is configured to adhere the melt transfer layer and the image receiving layer to the receptor element when the melt transfer article is heated with a hand iron.

8. The article of claim 1, wherein the image receiving layer is configured to receive printed images from electrostatic printers including both laser printers and liquid toner printers.

9. The article of claim 8, wherein the laser printer is capable of printing the printed images with OEM and non-OEM toners.

10. An image transfer article comprising:
a support comprising a top surface and a bottom surface;
a melt transfer layer on the top surface of the support,
an image receiving layer on the melt transfer layer, the image receiving layer having an image receiving surface configured to receive indicia or an image, the image receiving layer comprising a wax coated silica; and
an anti-static coating on the bottom surface of the support opposite the melt transfer layer.

11. The article of claim 10 wherein the image receiving layer further comprises at least one binder.

12. The article of claim 11 wherein the at least one binder comprises an ethylene acrylic acid binder.

13. The article of claim 10 wherein the wax coated silica comprises particles having a size of between about 4 and about 10 micrometers

14. The article of claim 10, wherein the imaging receiving layer includes a wax-based water repellant.

15. The article of claim 14, wherein the wax coated silica and wax-based water repellant comprise about 30% to about 40% of image receiving layer on a dry weight basis.

16. The article of claim 10, wherein the image transfer article exhibits good transfer characteristics with hand iron.

17. The article of claim 10, wherein the image receiving layer is configured to receive printed images from electrostatic printers including both laser printers and liquid toner printers.

18. The article of claim 16, wherein the laser printer is capable of printing the images with OEM and non-OEM toner.

19. A method of applying an image to a receptor, the method comprising:
printing an image on an image transfer article, the image transfer article comprising:
a substrate comprising a top surface and a bottom surface;
a melt transfer layer having a top surface and a bottom surface, the bottom surface removably located on the top surface of the substrate; and
an image receiving layer having an image receiving surface, wherein the image receiving layer comprises at least one wax coated silica,
wherein printing an image on an image transfer article comprises printing an image on the image receiving layer;
positioning the image transfer article on a receptor with the image receiving layer directly contacting the receptor;
heating the image transfer article on the receptor; and
removing the substrate.

20. The method of claim 18 wherein printing an image comprises printing an image using a laser printer.
